(19) United States
(12) Patent Application Publication
(10) Pub. No.: US 2019/0096397 A1
(43) Pub. Date: Mar. 28, 2019

(54) METHOD AND APPARATUS FOR PROVIDING FEEDBACK

(71) Applicant: GM GLOBAL TECHNOLOGY OPERATIONS LLC, Detroit, MI (US)

(72) Inventors: Ramzi Abdelmoula, Whitby (CA); Paul A. Donald, Courtice (CA); Shaun S. Marshall, Port Perry (CA)

(21) Appl. No.: 15/712,731

(22) Filed: Sep. 22, 2017

(51) Int. Cl. G10L 15/22; G10L 15/26; H04M 3/493

(52) U.S. Cl. CPC G10L 15/22; H04M 3/493; G10L 15/26

(57) ABSTRACT

A method and apparatus for providing occupant feedback are provided. The method includes detecting a trigger word uttered by the occupant, in response to detecting the trigger word, recording speech of the occupant corresponding to an issue and capturing context data corresponding to the issue, transmitting the speech and the context data to be analyzed to address the issue corresponding to the speech and the context data, and receiving information to address the issue and reproducing the information.

Apparatuses and methods consistent with exemplary embodiments relate to receiving feedback from an occupant. More particularly, apparatuses and methods consistent with exemplary embodiments relate to collecting information and feedback from an occupant and providing information to the occupant.

### SUMMARY

One or more exemplary embodiments provide a method and an apparatus that detect spoken input or feedback of an occupant and provide information to the occupant based on the spoken input. More particularly, one or more exemplary embodiments provide a method and an apparatus that detect a trigger word from an occupant in a vehicle, collect information from the occupant and the vehicle occupied by the occupant, and provide information to the occupant based on the collected information and voice input.

According to an aspect of an exemplary embodiment, a method for providing occupant feedback is provided. The method includes detecting a trigger word uttered by an occupant, in response to detecting the trigger word, recording speech of the occupant corresponding to an issue and capturing context data corresponding to the issue, transmitting the speech and the context data to be analyzed to address the issue corresponding to the speech and the context data, and receiving information to address the issue and reproducing the information.

The capturing context data may include analyzing the speech of the occupant to recognize keywords in the speech and storing vehicle data corresponding to the keywords as the context data.

the capturing the context data may further include analyzing the speech of the occupant to recognize a sentiment or mood of the occupant and storing the sentiment of the occupant as the context data.

The trigger word may consist of one word, a two word phrase, or three word phrase uttered by the occupant.

the transmitting the speech may include transmitting recognized text corresponding to the speech of the occupant.

The reproducing the information may include at least one from among displaying the information on a display in a vehicle and reproducing audio of the information on a speaker in a vehicle.

The information may include a software update corresponding to a vehicle component, the method further comprising updating software of the vehicle component with the software update.

According to an aspect of an exemplary embodiment, a method for providing occupant feedback is provided. The method includes receiving speech data and context data corresponding to an issue verbalized by an occupant of a vehicle, detecting keywords in the speech data and classifying the speech data, analyzing the context data, the keywords, and the classification of the speech data to generate information, and transmitting the information to the vehicle.

The context data may include vehicle data corresponding to the keywords as the context data.

The receiving speech data may include receiving text recognized from occupant's speech or receiving an audio file with occupant's speech.

The information may include at least one from among a software update corresponding to a vehicle component, displayable troubleshooting information corresponding to the keywords and context data, and audio troubleshooting information corresponding to the keywords and the context data.

According to an aspect of an exemplary embodiment, a system that provides occupant feedback is provided. The system includes at least one memory comprising computer executable instructions; and at least one processor configured to read and execute the computer executable instructions. The computer executable instructions cause the at least one processor to detect a trigger word uttered by an occupant, in response to detecting the trigger word, record speech of the occupant corresponding to an issue and capturing context data corresponding to the issue, transmit the speech and the context data to be analyzed to address the issue corresponding to the speech and the context data, and receive information to address the issue and reproducing the information.

The computer executable instructions may cause the at least one processor to detect keywords in the speech and classify the speech.

The computer executable instructions may cause the at least one processor to analyze the context data, the keywords, and the classification of the speech data to generate the information.

The context data may comprise vehicle data corresponding to the keywords as the context data.

The information may comprise at least one from among a software update corresponding to a vehicle component, displayable troubleshooting information corresponding to the keywords and context data, and audio troubleshooting information corresponding to the keywords and the context data.

The computer executable instructions may further cause the at least one processor to capture the context data by analyzing the speech of the occupant to recognize keywords in the speech and storing vehicle data corresponding to the keywords as the context data.

The computer executable instructions may further cause the at least one processor to capture the context data by analyzing the speech of the occupant to recognize a sentiment of the occupant and storing the sentiment of the occupant as the context data.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that provides occupant feedback according to an exemplary embodiment;

FIG. 2 shows a flowchart of a method of providing occupant feedback according to an exemplary embodiment;

FIG. 3 shows a system that provides occupant feedback according to an exemplary embodiment;

FIG. 4 shows a flow diagram of a system for collecting occupant feedback according to aspects of exemplary embodiments; and

FIG. 5 shows a system capable of providing occupant feedback according to an aspect of an exemplary embodiment.

### DETAILED DESCRIPTION

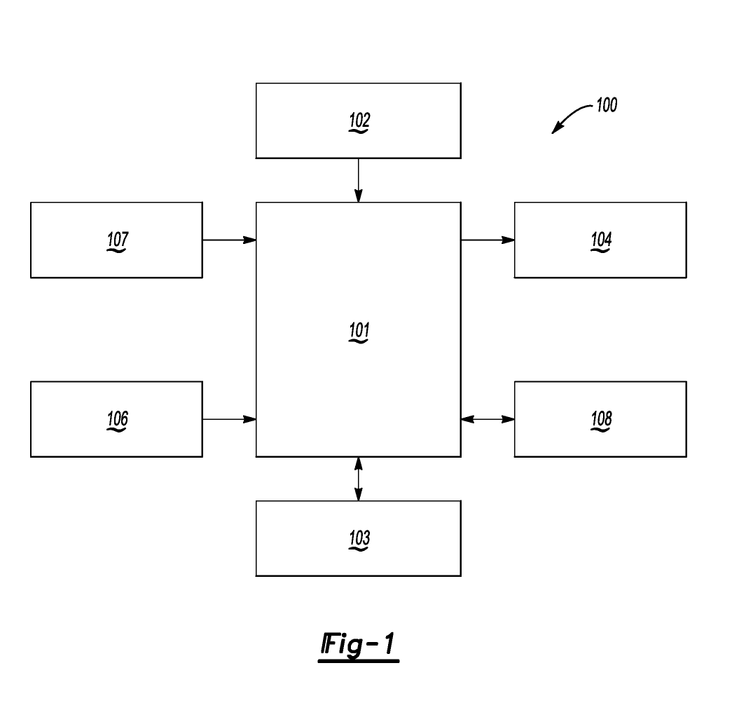

An apparatus and method that provide occupant feedback will now be described in detail with reference to FIGS. 1-5 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or combined into one or more devices. In addition, individual elements may be provided on separate devices.

Occupants or other persons riding in vehicles such as passenger cars, trucks, sports utility vehicles (SUVs), recreational vehicles (RVs), marine vessels, aircraft, etc., or occupying another space may experience into an issue or problem. Often times, the occupant may verbalize the issue and ask for help by calling troubleshooting helpline or pressing a button in a vehicle to connect with an advisor or expert that can assist with the issue. However, the process of dialing a number or pressing a button may prove difficult while performing another task such as driving. In addition, an occupant may be unable to provide additional information to the advisor or expert that may be useful for addressing the issue or problem.

One way to address the difficulty of calling an advisor or pressing a button to connect with an advisor is to provide a voice trigger or voice command to start the process of collecting occupant feedback and addressing the issue. The voice trigger or voice command may be a simple command or phrase consisting of no more than one, two or a few words. Upon detecting the voice trigger or command, the system may initiate recording of the occupant's voice, analyzing the content of the occupant's speech, and retrieving information from sensors or systems corresponding to the content of the occupant's speech. The information and the content of the occupant's speech may be transmitted to a backend system or advisor, and one or both of which can then attempt to resolve the issue or provide a solution to the occupant.

FIG. 1 shows a block diagram of an apparatus that provides occupant feedback 100 according to an exemplary embodiment. As shown in FIG. 1, the apparatus that provides occupant feedback 100, according to an exemplary embodiment, includes a controller 101, a power supply 102, a storage 103, an output 104, a user input 106, a vehicle sensor 107, and a communication device 108. However, the apparatus that provides occupant feedback 100 is not limited to the aforementioned configuration and may be configured to include additional elements and/or omit one or more of the aforementioned elements. The apparatus that provides occupant feedback 100 may be implemented as part of a vehicle or as a standalone component.

The controller 101 controls the overall operation and function of the apparatus that provides occupant feedback 100. The controller 101 may control one or more of a storage 103, an output 104, a user input 106, a vehicle sensor 107, and a communication device 108 of the apparatus that provides occupant feedback 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the user input 106, the vehicle sensor 107, and the communication device 108 of the apparatus that provides occupant feedback 100. The information may be sent and received via a bus or network, or may be directly read or written to/from one or more of the storage 103, the output 104, the user input 106, the vehicle sensor 107, and the communication device 108 of the apparatus that provides occupant feedback 100. Examples of suitable network connections include a controller area network (CAN), a media oriented system transfer (MOST), a local interconnection network (LIN), a local area network (LAN), and other appropriate connections such as Ethernet.

The power supply 102 provides power to one or more of the controller 101, the storage 103, the output 104, the user input 106, the vehicle sensor 107, and the communication device 108 of the apparatus that provides occupant feedback 100. The power supply 102 may include one or more from among a battery, an outlet, a capacitor, a solar energy cell, a generator, a wind energy device, an alternator, etc.

The storage 103 is configured to store information and retrieve information used by the apparatus that provides occupant feedback 100. The storage 103 may be controlled by the controller 101 to retrieve and store information from the vehicle sensors 107 and vehicle system modules. In addition, the storage 103 may store information about the content of an occupant input such as a voice command, a trigger word, recorded speech of the occupant, an utterance, spoken input, or text recognized from the occupant's speech or utterance. In one example, the storage 103 may also store information about the mood or sentiment of the occupant or context data corresponding to the voice input of the occupant. The storage 103 may also include the computer instructions configured to be executed by a processor to perform the functions of the apparatus that provides occupant feedback 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 is configured to output information in one or more forms including: visual, audible and/or haptic form. The output 104 may be controlled by the controller 101 to provide outputs to the user of the apparatus that provides occupant feedback 100. The output 104 may include one or more from among a speaker, a display, a transparent display, a centrally-located display, a head up display, a windshield display, a haptic feedback device, a vibration device, a tactile feedback device, a tap-feedback device, a holographic display, an instrument light, an indicator light, a horn, a piezoelectric device, etc. In addition, the output 104 may also include a transparent display located on one or more of a windshield, a rear window, side windows, and mirrors of a vehicle.

The output 104 may output a notification including one or more from among an audible notification, a light notification, and a display notification. The notification may include information corresponding to the voice input of the occupant or information that addresses the issue raised by the occupant. The output 104 may display a graphical indicator to attract a user's attention to the alert or notification in addition to outputting the information audibly via a speaker.

The user input 106 is configured to provide information and commands to the apparatus that provides occupant feedback 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc.

The user input 106 may listen for a trigger word input the occupant. Once the trigger word is detected, the user input 106 may record the voice input of the occupant. The user input 106 may be configured to receive a user input to acknowledge or dismiss the alert or notification output by the output 104. The user input 106 may also be configured to receive a user input to cycle through notifications or different screens of a notification.

The vehicle sensor 107 is configured to detect the status of vehicle system modules, vehicle components or provide context information related to the occupant or vehicle. The vehicle sensor 107 may provide information about the performance of vehicle system modules, vehicle components, etc.

The communication device 108 may be used by the apparatus that provides occupant feedback 100 to communicate with various types of external apparatuses according to various communication methods. According to one example, the communication device 108 may be configured to send/receive context information, information from the user input to/from the controller 101 of the apparatus that provides occupant feedback 100. The communication device 108 may be configured to transmit the context information and information about the user input 106 to a backend server or advisor. In addition, the communication device 108 may be configured to receive information to address an issue raised by the occupant feedback or information corresponding to the content of the occupant feedback from a backend server or advisor. According to another example, the communication device 108 may receive software updates corresponding to the occupant feedback, voice input and/or context information from a backend server.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long term evolution (LTE), Bluetooth, EVDO, CDMA, GPRS, EDGE or ZigBee

The controller 101 of the apparatus that provides occupant feedback 100 may be configured to detecting a trigger word uttered by the occupant, in response to detecting the trigger word, record speech of the occupant corresponding to an issue and capturing context data corresponding to the issue, transmit the speech and the context data to be analyzed to address the issue corresponding to the speech and the context data, and receive information to address the issue and reproducing the information.

The controller 101 of the apparatus that provides occupant feedback 100 may also be configured to capture context data by analyzing the speech of the occupant to recognize keywords in the speech and storing vehicle data corresponding to the keywords as the context data.

The controller 101 of the apparatus that provides occupant feedback 100 may also be configured to capture the context data further by analyzing the speech of the occupant to recognize a sentiment or mood of the occupant and storing the sentiment of the occupant as the context data.

The controller 101 of the apparatus that provides occupant feedback 100 may also be configured to control to transmit recognized text corresponding to the speech of the occupant. In addition, the controller 101 of the apparatus that provides occupant feedback 100 may be configured to control to display the information on a display in a vehicle and reproduce audio of the information on a speaker in a vehicle. Moreover, the controller 101 of the apparatus that provides occupant feedback 100 may be configured to update software of a vehicle component with the software received via the communication 108. The software may address the issue raised by the voice input of the occupant.

The controller 101 of the apparatus that provides occupant feedback 100 may be configured to receive speech data and context data corresponding to an issue verbalized by an occupant of a vehicle, detect keywords in the speech data and classifying the speech data, analyze the context data, the keywords, and the classification of the speech data to generate information, and transmit the information to the vehicle. The speech data may include text recognized from occupant's speech or an audio file with occupant's speech and the context data may include vehicle data corresponding to the keywords.

The information to be transmitted may include one or more from among a software update corresponding to a vehicle component, displayable troubleshooting information corresponding to the keywords and context data, and audio troubleshooting information corresponding to the keywords and the context data.

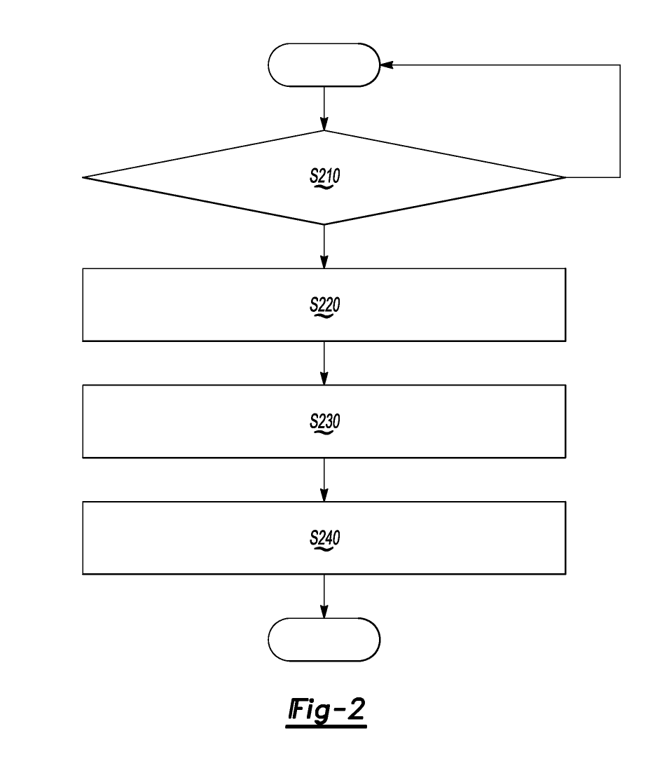

FIG. 2 shows a flowchart for a method of providing occupant feedback according to an exemplary embodiment. The method of FIG. 2 may be performed by the apparatus that provides occupant feedback 100 or may be encoded into a computer readable medium as instructions that are executable by a computer to perform the method.

Referring to FIG. 2, speech of an occupant is monitored and it is determined whether a trigger word is detected in the speech in operation 5210 and Operation S210—No. If it is determined that the trigger word is detected in the speech of the occupant (operation S210—Yes), the speech of the occupant following the trigger words is recorded and context data corresponding to an issue determined from the speech of the occupant is captured in operation S220.

In operation 5230, the captured speech and context data is transmitted to by analyzed a backend to address the issue. After a solution or resolution is determined at the backend, information corresponding to the resolution or potential solution is received and the information is reproduced to be heard, displayed or to address the issue raised by the occupant in operation 5240.

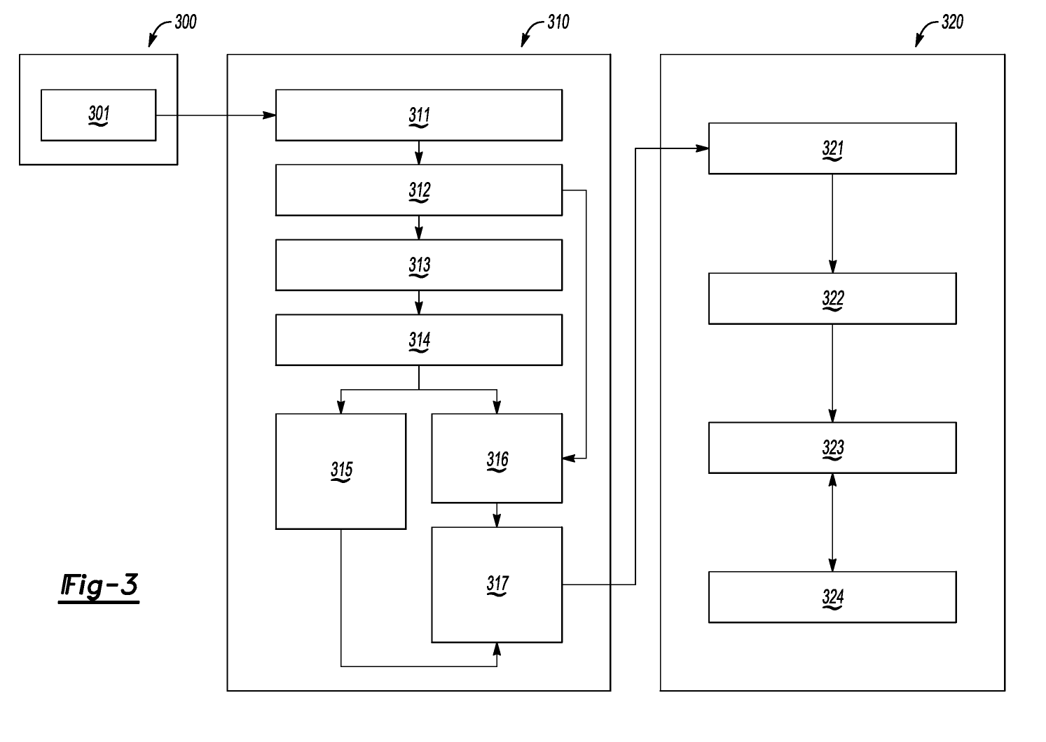

FIG. 3 shows a system that provides occupant feedback according to an exemplary embodiment. The system of FIG. 3 may be performed by the apparatus that provides occupant feedback 100 or may be encoded into a computer readable medium as instructions that are executable by one or more computers to perform the method.

Referring to FIG. 3, an occupant 300 may input a voice input 301. The voice input may include a voice trigger command followed by voice input about an issue raised by the occupant or feedback of the occupant. The voice trigger command is detected by in a vehicle system 310 in operation 311. After the voice trigger command is detected, the spoken input of the occupant is recorded and saved to an audio file in storage 103 in operation 312. The recorded voice input may be converted to text in operation 313. Moreover, keywords and vehicle components corresponding to the content of the text may be determined in operation 314.

In operation 315, context data corresponding to the keywords and content of the text may also be determined. Further, in operation 316, the mood or sentiment of occupant is determined from the audio file and/or content of the text. Next, the context data, text, and keywords may be transmitted to backend server 320 in operation 317. Although operations 313-316 are shown as part of vehicle system 310, these operations may be performed by backend server 320 and the captured audio file may be transmitted to backend server 320 in order for operations 313-316 to be performed by the backend server 320.

The backend server 320 may receive information on one or more of the audio file of the occupant feedback, text file of occupant feedback, keywords, and context data and classify the received information in operation 321. The received information may be stored in a database in operation 322 and analyzed in operation 323. The analysis may be performed by an advisor or the backend server 320. The analysis is then used to generate feedback reports to address the issue raised by the occupant in operation 324.

In operation 324, the backend server 320 may generate feedback reports. The feedback reports may include one or more of an engineering report sent to an engineer responsible for the system corresponding to the occupant's feedback, a report to be sent to the occupant to address the issue raised by the occupant, and a management report to be sent to senior management to follow up on correcting the issue raised by the occupant. The report sent to the occupant may be transmitted to vehicle system 320 and include the software update to address the issue raised by the occupant and information to be displayed or played back to the occupant to address the issue.

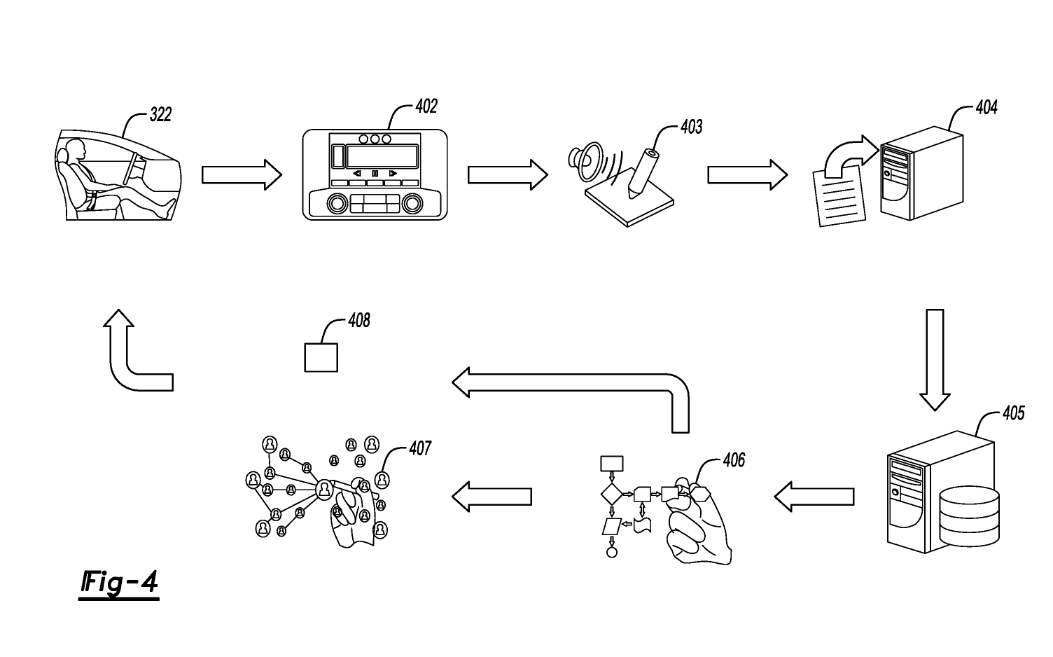

FIG. 4 shows a flow diagram of a method of providing occupant feedback according to aspects of exemplary embodiments. The flow diagram of FIG. 4 is merely an example and other flows may be used to address the issue raised by the occupant.

Referring to FIG. 4, an occupant may have a complaint or an issue with a vehicle or component in operation 401. The occupant may state a trigger word, e.g., a short phrase or word consisting of no more than 4 words to initiate the recording of the occupant feedback in operation 403. The feedback is then provided to back server in operation 404. The backend server or advisor analyzes the data in operation 405. The analysis is used to determine a feature or component corresponding to the issue raised by the occupant in operation 406 and data is provided to the appropriate persons, advisors, engineers and backend servers in operations 407. In operation 408, information addressing the issue raised by the occupant is collected from the appropriate persons, advisors, engineers and backend servers, reviewed and transmitted to the occupant.

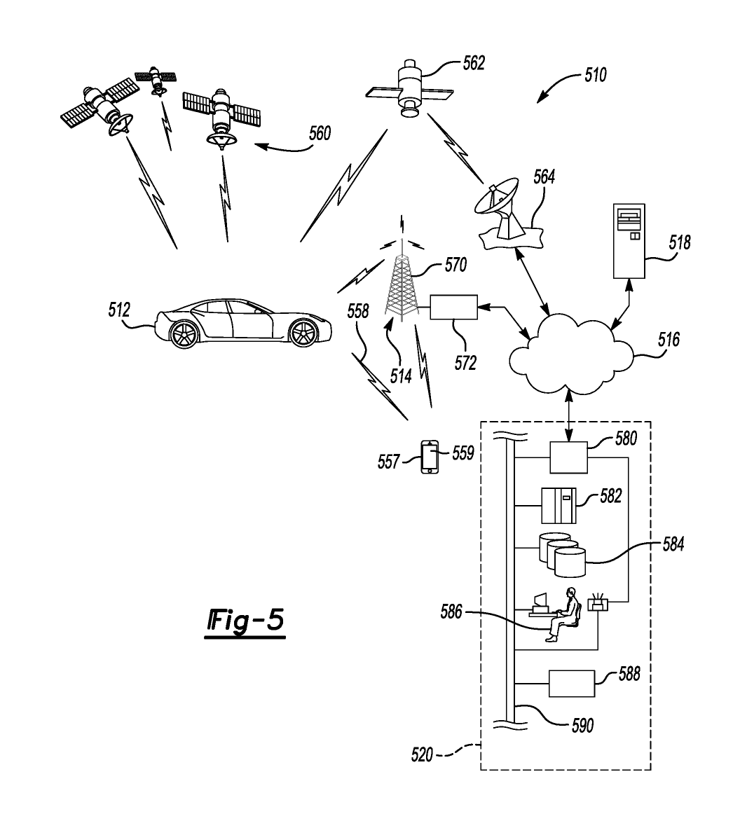

FIG. 5 shows an illustration of an operating environment that comprises a mobile vehicle communications system 510 and that can be used to implement the apparatus and the method that provide occupant feedback disclosed herein.

Referring to FIG. 5, an operating environment that comprises a mobile vehicle communications system 510 and that can be used to implement the apparatus and the method for providing occupant feedback is shown. Communications system 510 may include one or more from among a vehicle 512, one or more wireless carrier systems 514, a land communications network 516, a computer 518, and a call center 520. It should be understood that the disclosed apparatus and the method for providing occupant feedback can be used with any number of different systems and is not specifically limited to the operating environment shown here. The following paragraphs simply provide a brief overview of one such communications system 510; however, other systems not shown here could employ the disclosed apparatus and the method for providing occupant feedback as well.

Vehicle 512 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. One or more elements of apparatus that provides occupant feedback 100 shown in FIG. 1 may be incorporated into vehicle 512.

One of the networked devices that can communicate with the communication device 108 is a wireless device, such as a smart phone 557. The smart phone 557 can include computer-processing capability, a transceiver capable of communicating using a short-range wireless protocol 558, and a visual smart phone display 559. In some implementations, the smart phone display 559 also includes a touch-screen graphical user interface and/or a GPS module capable of receiving GPS satellite signals and generating GPS coordinates based on those signals. One or more elements of apparatus that provides occupant feedback 100 shown in FIG. 1 may be incorporated into smart phone 557.

The GPS module of the communication device 108 may receive radio signals from a constellation 560 of GPS satellites, recognize a location of a vehicle based on the on board map details or by a point of interest or a landmark. From these signals, the communication device 108 can determine vehicle position that is used for providing navigation and other position-related services to the vehicle driver. Navigation information can be presented by the output 104 (or other display within the vehicle) or can be presented verbally such as is done when supplying turn-by-turn navigation. The navigation services can be provided using a dedicated in-vehicle navigation module or some or all navigation services can be done via the communication device 108. Position information may be sent to a remote location for purposes of providing the vehicle with navigation maps, map annotations (points of interest, restaurants, etc.), route calculations, and the like. The position information can be supplied to call center 520 or other remote computer system, such as computer 518, for other purposes, such as fleet management. Moreover, new or updated map data can be downloaded by the communication device from the call center 520. In one example, position information may be used by the apparatus that provides occupant feedback 100 shown in FIG. 1 to determine whether a reminder should be output or re-output.

The vehicle 512 may include vehicle system modules (VSMs) in the form of electronic hardware components that are located throughout the vehicle and typically receive input from one or more sensors and use the sensed input to perform diagnostic, monitoring, control, reporting and/or other functions. Each of the VSMs may be connected by a communications bus to the other VSMs, as well as to the controller 101, and can be programmed to run vehicle system and subsystem diagnostic tests. The controller 101 may be configured to send and receive information from the VSMs and to control VSMs to perform vehicle functions. As examples, one VSM can be an engine control module (ECM) that controls various aspects of engine operation such as fuel ignition and ignition timing, another VSM can be an external sensor module configured to receive information from external sensors such as cameras, radars, LIDARs, and lasers, another VSM can be a powertrain control module that regulates operation of one or more components of the vehicle powertrain, and another VSM can be a body control module that governs various electrical components located throughout the vehicle, like the vehicle's power door locks and headlights. According to an exemplary embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 512, as numerous others are also available.

Wireless carrier system 514 may be a cellular telephone system that includes a plurality of cell towers 570(only one shown), one or more mobile switching centers (MSCs) 572, as well as any other networking components required to connect wireless carrier system 514 with land network 516. Each cell tower 570 includes sending and receiving antennas and a base station, with the base stations from different cell towers being connected to the MSC 572 either directly or via intermediary equipment such as a base station controller. Cellular system 514 can implement any suitable communications technology, including for example, analog technologies such as AMPS, or the newer digital technologies such as CDMA (e.g., CDMA2000 or 1xEV-DO) or GSM/GPRS (e.g., 4G LTE). As will be appreciated by those skilled in the art, various cell tower/base station/MSC arrangements are possible and could be used with wireless system 514. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 514, a different wireless carrier system in the form of satellite communication can be used to provide uni-directional or bi-directional communication with the vehicle. This can be done using one or more communication satellites 562 and an uplink transmitting station 564. Uni-directional communication can be, for example, satellite radio services, wherein programming content (news, music, etc.) is received by transmitting station 564, packaged for upload, and then sent to the satellite 562, which broadcasts the programming to subscribers. Bi-directional communication can be, for example, satellite telephony services using satellite 562 to relay telephone communications between the vehicle 512 and station 564. If used, this satellite telephony can be utilized either in addition to or in lieu of wireless carrier system 514.

Land network 516 may be a land-based telecommunications network that is connected to one or more landline telephones and connects wireless carrier system 514 to call center 520. For example, land network 516 may include a public switched telephone network (PSTN) such as that used to provide hardwired telephony, packet-switched data communications, and the Internet infrastructure. One or more segments of land network 516 could be implemented with a standard wired network, a fiber or other optical network, a cable network, power lines, other wireless networks such as wireless local area networks (WLANs), or networks providing broadband wireless access (BWA), or any combination thereof. According to an example, call center 520 may not be connected via land network 516, but may include wireless telephony equipment so that it can communicate directly with a wireless network, such as wireless carrier system 514.

Computer 518 can be one of a number of computers accessible via a private or public network such as the Internet. Each such computer 518 can be used for one or more purposes, such as a web server accessible by the vehicle via the communication device 108 and wireless carrier 514. Other such accessible computers 518 can be, for example: a service center computer where diagnostic information and other vehicle data can be uploaded from the vehicle via the communication device 108; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 512 or call center 520, or both. A computer 518 can also be used for providing Internet connectivity such as DNS services or as a network address server that uses DHCP or other suitable protocol to assign an IP address to the vehicle 512.

Call center 520 is designed to provide the vehicle electronics with a number of different system back-end functions and, according to the exemplary embodiment shown here, generally includes one or more switches 580, servers 582, databases 584, live advisors 586, as well as an automated voice response system (VRS) 588. These various call center components may be coupled to one another via a wired or wireless local area network 590. Switch 580, which can be a private branch exchange (PBX) switch, routes incoming signals so that voice transmissions are usually sent to either the live adviser 586 by regular phone or to the automated voice response system 588 using VoIP. The live advisor phone can also use VoIP as indicated by the broken line in FIG. 5. VoIP and other data communication through the switch 580 is implemented via a modem (not shown) connected between the switch 580 and network 590. Data transmissions are passed via the modem to server 582 and/or database 584. Database 584 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 520 using live advisor 586, it will be appreciated that the call center can instead utilize VRS 588 as an automated advisor or, a combination of VRS 588 and the live advisor 586 can be used.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

1. A method for providing occupant feedback, the method comprising:
detecting a trigger word uttered by an occupant;
in response to detecting the trigger word, recording speech of the occupant corresponding to an issue and capturing context data corresponding to the issue;
transmitting the speech and the context data to be analyzed to address the issue corresponding to the speech and the context data; and
receiving information including a software update to address the issue raised by the occupant of the vehicle and updating software of the vehicle component with the software update.

2. The method of claim 1, wherein the capturing context data comprises analyzing the speech of the occupant to recognize keywords in the speech and storing vehicle data corresponding to the keywords as the context data.

3. The method of claim 2, wherein the capturing the context data further comprises analyzing the speech of the occupant to recognize a sentiment or mood of the occupant and storing the sentiment of the occupant as the context data.

4. The method of claim 1, wherein the trigger word consists of one word, a two word phrase, or three word phrase uttered by the occupant.

5. The method of claim 1, wherein the transmitting the speech comprises transmitting recognized text corresponding to the speech of the occupant.

6. The method of claim 1, further comprising at least one from among displaying the information on a display in a vehicle and reproducing audio of the information on a speaker in a vehicle.

7. (canceled)

8. A non-transitory computer readable medium comprising computer executable instructions executable by a processor to perform the method of claim 1.

9. A method for providing occupant feedback, the method comprising:
receiving speech data and context data corresponding to an issue verbalized by an occupant of a vehicle;
detecting keywords in the speech data and classifying the speech data;
analyzing the context data, the keywords, and the classification of the speech data to generate information; and
transmitting the information including a software update to the vehicle to address the issue raised by the occupant of the vehicle by updating software of the vehicle component with the software update.

10. The method of claim 9, wherein the context data comprises vehicle data corresponding to the keywords as the context data.

11. The method of claim 9, wherein the receiving speech data comprises receiving text recognized from occupant's speech or receiving an audio file with occupant's speech.

12. The method of claim 9, wherein the information further comprises at least one from among displayable troubleshooting information corresponding to the keywords and context data and audio troubleshooting information corresponding to the keywords and the context data.

13. A non-transitory computer readable medium comprising computer executable instructions executable by a processor to perform the method of claim 9.

14. A system that provides occupant feedback, the system comprising:
at least one memory comprising computer executable instructions; and
at least one processor configured to read and execute the computer executable instructions, the computer executable instructions causing the at least one processor to:
detect a trigger word uttered by an occupant;
in response to detecting the trigger word, record speech of the occupant corresponding to an issue and capturing context data corresponding to the issue;
transmit the speech and the context data to be analyzed to address the issue corresponding to the speech and the context data; and
receive information including a software update to address the issue raised by the occupant of the vehicle and updating software of the vehicle component with the software updater.

15. The apparatus of claim 14, wherein the computer executable instructions cause the at least one processor to detect keywords in the speech and classify the speech.

16. The apparatus of claim 15, wherein the computer executable instructions cause the at least one processor to analyze the context data, the keywords, and the classification of the speech to generate the information.

17. The apparatus of claim 14, wherein the context data comprises vehicle data corresponding to the keywords as the context data.

18. The apparatus of claim 14, wherein the information further comprises at least one from among displayable troubleshooting information corresponding to the keywords and context data and audio troubleshooting information corresponding to the keywords and the context data.

19. The apparatus of claim 14, wherein the computer executable instructions further cause the at least one processor to capture the context data by analyzing the speech of the occupant to recognize keywords in the speech and storing vehicle data corresponding to the keywords as the context data.

20. The apparatus of claim 19, wherein the computer executable instructions further cause the at least one processor to capture the context data by analyzing the speech of the occupant to recognize a sentiment of the occupant and storing the sentiment of the occupant as the context data.
